(19) United States
(12) Patent Application Publication
(10) Pub. No.: US 2007/0229196 A1
(43) Pub. Date: Oct. 4, 2007

(54) WAVEGUIDE TRANSITION FOR PRODUCTION OF CIRCULARLY POLARIZED WAVES

(76) Inventors: Daniel Schultheiss, Hornberg (DE); Josef Fehrenbach, Haslach (DE); Karl Griessbaum, Muehlenbach (DE)

Correspondence Address: FAY KAPLUN & MARCIN, LLP, 15O BROADWAY, SUITE 702, NEW YORK, NY, 10038, US

(21) Appl. No.: 11/695,792

(22) Filed: Apr. 3, 2007

Related U.S. Application Data
(60) Provisional application No. 60/788,919, filed on Apr. 3, 2006.

(30) Foreign Application Priority Data
Apr. 3, 2006 (DE) 10 2006 015 338.3

(51) Int. Cl. H01P 1/161; H01P 5/107

(52) U.S. Cl. 333/21 A; 333/26

(57) ABSTRACT

A waveguide transition for a filling level radar is provided, which has a planar emitting element, which cooperates with two lines, such that circularly polarized electromagnetic transmitting signals can be coupled from the lines into a waveguide. With the thus-existing planar coupling, the necessity for an additional resonance chamber in the area of the coupling may be eliminated.

### CLAIM OF PRIORITY

This application claims the benefit of the filing date of German Patent Application Serial No. 10 2006 015 338.3 filed Apr. 3, 2006 and U.S. Provisional Patent Application Ser. No. 60/788,919 filed Apr. 3, 2006, the disclosure of each application is hereby incorporated herein by reference.

### FIELD OF THE INVENTION

The present invention relates to filling level measurement. In particular, the present invention relates to a waveguide transition for the production of circularly polarized waves for a filling level radar, a microwave module for a filling level radar with such a waveguide transition, a filling level radar for determining a filling level in a tank, and the use of such a waveguide transition for filling level measurement.

### TECHNOLOGICAL BACKGROUND

Known filling level devices have transmitting- and receiving electronics in addition to an antenna for transmitting or receiving radar waves, by means of which the transmitting signals are produced and the measurement signals received by the antenna are evaluated. In addition, a coupling is provided, which is designed for coupling the electromagnetic waves generated within the filling level measurement device in a waveguide or for uncoupling the received signal from the waveguide.

For realizing planar coupling structures in a waveguide, generally elongation of a microstrip conductor, whose open end projects in a waveguide, may be considered.

DE 100 23 497 A1 discloses a coupling in a waveguide, which comprises a single microstrip conductor, which projects laterally into the waveguide.

DE 198 00 306 A1 discloses a planar emission element (so called patch antenna), which is arranged as a single patch in the waveguide. The coupling of the electromagnetic waves in the waveguide in this regard is axially provided.

For production of circular waves, a transmitting signal is subdivided in equal parts and supplied with 90° phase displacement, to, for example, two coupling pins rotated at 90° to one another, in a waveguide. If the subdivision of the transmitting signal in the respective half does not occur, an elliptical wave arises.

Such an arrangement of two coupling pins, which extend into the waveguide, may be mechanically demanding and may require increased manufacturing expense, since the pins must be fixed mechanically, for example, to the waveguide.

### SUMMARY OF THE INVENTION

According to an exemplary embodiment of the present invention, a waveguide transition for producing circularly polarized waves for a filling level radar is provided, the waveguide including a first line (or conductor), a second line (or conductor) and a planar emitter element, whereby the first line, the second line and the planar emitter element interact with each other, such that during operation of the filling level radar, a coupling of a circularly or elliptically polarized electromagnetic transmitting signal from the lines into a waveguide occurs.

The coupling of the circularly or elliptically polarized signals occurs, therefore, not via two coupling pins arranged at an angle of 90° to one another, but in the form of a planar coupling, which emits a circularly or elliptically polarized wave in the waveguide. Such a planar coupling may require only relatively minimal manufacturing expense, since it may be integrated, for example, in a corresponding circuit board and may be built in easily into a waveguide or waveguide terminal.

According to a further embodiment of the present invention, the waveguide transition further includes a waveguide terminal for connecting the waveguide, an antenna or a process separator.

The waveguide transition, therefore, may be made as a modular component with an already integrated waveguide terminal, to which then either a further waveguide or an antenna or a corresponding process separator, for example in the form of a dielectric device, can be connected directly.

The electronics of the filling level radar may be connected then to both lines.

The antenna may be a horn aerial, for example. Naturally, however, other forms of antenna, for example, rod antennae, are possible.

According to a further exemplary embodiment of the present invention, both lines project into the waveguide terminal.

The emitting planar emitter element therefore is smaller than the waveguide or the waveguide terminal. Typically thicknesses of the emitter element lies in the range of less than 100 μm, for example.

According to a further exemplary embodiment of the present invention, the planar emitter element has a planar structure with two sides lying perpendicular to one another. Generally, the planar emitter element may take all known shapes, such as, for example, a square shape, triangular shape, circular segment shape, or another shape.

According to a further exemplary embodiment of the present invention, the waveguide transition for generation of an electromagnetic transmitting signal is formed with two polarizing planes, whereby the two lines have an angle of 90° relative to one another.

According to a further exemplary embodiment of the present invention, the ends of the two lines each have a widening or narrowing.

In this manner, the emission characteristic of the conductors may be varied and optimized depending on the application.

According to another exemplary embodiment of the present invention, the planar emitter element is embodied as a conductive element.

For example, the emitter element may be made of metal or a metal alloy. Also semi-conductive materials may be possible.

Thus, a plurality of variation possibilities may be provided, so that the waveguide transition can be converted accordingly, depending on the requirements.

According to a further exemplary embodiment of the present invention, the lines are embodied as a microstrip. For example, the lines and the plane emitter element are formed integrally in a blank manufacturing process of a blank substrate. In this manner, the production costs may be minimized substantially. The finished blank then may be installed in a simple manner as a single component in the waveguide.

According to a further exemplary embodiment of the present invention, the blank substrate has an electrically conductive layer on the surface facing away from the emitter element, which is formed for closing off the waveguide.

This type of coupling therefore may not require an additional resonance chamber in the area of the coupling, since the circuit board closes the waveguide in the back with its ground surface.

According to a further exemplary embodiment of the present invention, the blank substrate has a first dielectricity constant ε₁. The waveguide terminal, however, is filled with a material, which has a second dielectricity constant ε₂, whereby ε₁ is greater than ε2.

In this manner, for example, the dimensions of the emitter element may be smaller than the diameter of the waveguide. The filling of the waveguide terminal with a dielectric may generally lead to a sealing of the waveguide transition, to increased stability, improved chemical resistance, and increased durability.

According to a further exemplary embodiment of the present invention, the waveguide transition for coupling the electromagnetic transmitting signal is embodied with a frequency between 6 GHz and 100 GHz in the waveguide. For example, the waveguide transition is embodied for a frequency of 6.3 GHz or for a frequency of 26 GHz or for frequencies between 77 GHz and 80 GHz.

Naturally, the waveguide transition may also can be reduced or enlarged, so that higher or lower frequencies may be used.

According to a further exemplary embodiment of the present invention, the waveguide transition includes a first recess for guiding the first line through the waveguide terminal and a second recess for guiding the second line through the waveguide terminal, whereby the first recess and the second recess are formed, such that they only insignificantly effect an electromagnetic field of the underlying first or second lines.

The recesses then are selected to be of a size that the electromagnetic field may only be affected minimally. On the other hand, the size of the recesses is established, such that only a known highest energy comes from the waveguide, so that an unwanted emission on the side may be limited.

According to a further exemplary embodiment of the present invention, a microwave module for a filling level radar with an above-described waveguide transition is provided.

Such a microwave module can be installed together with the waveguide transition as a modular component in a filling level radar. In this manner, maintenance expense is reduced, since the microwave module is exchangeable as a complete component.

According to a further exemplary embodiment of the present invention, a filling level radar for determining a filling level in a tank is provided, the filling level radar including an antenna for transmitting and/or receiving electromagnetic waves and a waveguide transition, as described above.

In addition, the use of an above-described waveguide transition for filling level measurement is provided.

Next, exemplary embodiments of the present invention will be described with reference to the figures.

### BRIEF DESCRIPTION OF THE FIGURES

FIG. 1 shows a schematic representation of a microwave module with a waveguide transition according to one exemplary embodiment of the present invention.

FIG. 2 shows a schematic cross-sectional representation of the waveguide transition of FIG. 1.

FIG. 3 shows a schematic, perspective representation of a waveguide transition according to a further exemplary embodiment of the present invention.

FIG. 4 shows a schematic representation of a filling level radar according to one exemplary embodiment of the present invention.

### DETAILED DESCRIPTION

The representations in the figures are schematic and not to scale.

In the following description of the figures, the same reference numerals are used for the same or similar elements.

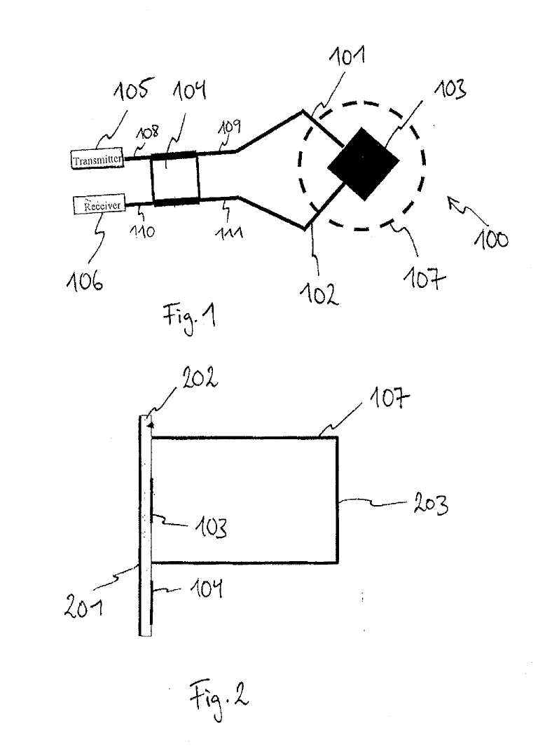

FIG. 1 shows a schematic representation of a block diagram of a microwave module 100 with a waveguide transition or waveguide transformer 101, 102, 103, 107 according to one embodiment of the present invention. The microwave module 100 has a transmitting pulse oscillator (Tx oscillator) as part of the transmitting unit 105. The electromagnetic signal produced there is, for example, conducted via a band-pass filter as a signal 108 to the transmitting coupler 104.

The transmitting coupler 104 is embodied, for example, as a symmetrical or asymmetrical hybrid coupler. The signal 108 passes through the transmitting coupler 104 with relative minimal damping and is conducted as signal 109 to the first line 101. The first line 101 is connected to the planar emitter element 103, which is located within the waveguide terminal 107.

The hybrid coupler 104 further is connected with a second line 102, which likewise is connected to the planar emitter element 103. Via the second line 102, a second electromagnetic signal 111 can be transmitted to the emitter element 103.

The second electromagnetic signal 111 is phase-displaced for example at 90° to the first electromagnetic signal 109.

The first line 101, the second line 102 and the planar emitter element 103 operate together, such that during operation of the filling level radar, coupling of a circularly or elliptically polarized electromagnetic transmitting signal from the line 101, 102 into the waveguide or waveguide terminal 107 takes place.

The waveguide terminal 107 is embodied, for example, for connecting a further waveguide.

The further waveguide or waveguide terminal 107 is connected with an antenna system (not shown in FIG. 1), via which a measurement pulse may be emitted, which then is reflected as a receiving signal by the object to be measured or the medium to be measured (which, for example, is a filling material).

With the use of circularly polarized waves, with the reflection on a surface, the feature is provided that the rotational direction of the field may be changed. Thus, for example, a left-rotating circularly polarized receiving signal is provided from a right-rotating circularly polarized transmitting signal. The receiving signal changed in its rotational direction is subsequently received again by the antenna system and leads to two measurement signals 109 and 111 that are phase-displaced to one another at 90°, which are transmitted to the transmitting coupler 104.

The transmitting coupler 104 forwards both received measurement signals 109 and 11 to the receiver circuit 106 as a combined signal 110.

The receiver circuit 106 has a pulse generator and a band-pass filter, for example, which produce a pulse signal and forwards to a sampling mixer likewise contained in the receiver circuit 106. In this sampling mixer, the receiving signal 110 is scanned by the pulse signal produced in the pulse generator of the receiver circuit and expanded in time. The thus-produced signal is amplified subsequently by an amplifier and then is made available to a corresponding output as a ZF signal for evaluation and determination of the filling level.

In the area of filling level measurement technology with radar sensors, systems with circularly polarized waves may offer advantages. For one, the number of received echoes may be reduced such that noise reflections which are generated by 2, 4, 6, or another even number of reflections, may be changed twice in the rotational direction of the field and therefore an incorrect phase displacement may be applied to the inlet of the hybrid coupler. Thus, these echoes may not move into the receiver but back into the transmitter where they are damped strongly. All echoes, which underlie 1, 3, 5 or another uneven number of reflections, are transmitted through the correct phase relation of both measurement signals 109 and 11 to the receiver. Furthermore, use of the transmitting power of a generator may be improved.

Up to now, a large part of the transmitting power is conducted via a directional coupler into a wave sump/marsh or drain. The smaller portion serves as transmitting signals. By using such a directional coupler as transmitting-/receiving filter, a minimal insertion loss at least in the receiving channel may be provided, in the transmitting branch, in contrast, a corresponding amount. Another possibility is the use of a circulator, which has in the transmitting branch as well as in the receiving branch a minimal transmission loss, but which may be quite expensive.

With the arrangement shown in FIG. 1, a robust, mechanically stable, easy and simple to manufacture planar coupling may be realized, which emits a circularly polarized wave in a waveguide.

FIG. 2 shows a schematic cross-sectional representation of the microwave module with the waveguide transition according to the present invention shown in FIG. 1. A circuit board 202 is mounted to the waveguide terminal 107, which has a metal coating 201 on a back side. On its front side, the blank 202 has both lines 101, 102 (not seen in FIG. 2), the planar emitting element 103 and the hybrid coupler 104.

This type of coupling requires no additional resonance chamber in the area of the coupling, since the circuit board 202 closes the waveguide 107 to the back with its ground surface 201.

In this manner, a simple mechanical structure of the module 100 may be provided. In the waveguide 107, only recesses for guiding through the microstrip conductors 101, 102 must be machined between the hybrid coupler 104 and the emitter element 103. These recesses, for example, are selected to be of a size that they do not affect the electromagnetic field of the underlying microstrip conductors. On the other hand, they cannot be too large, since in that case, too much energy would be emitted from the waveguide 107, which leads to an unwanted emission on the side.

On the open waveguide end, a horn antenna or a further waveguide (not shown in FIG. 2) or any type of process separation 203, for example, a dielectric, is connected.

If the circuit board 202 does not have a metal coating 201 on the back side, a resonator with a cover may be provided, in order to close off the waveguide 107.

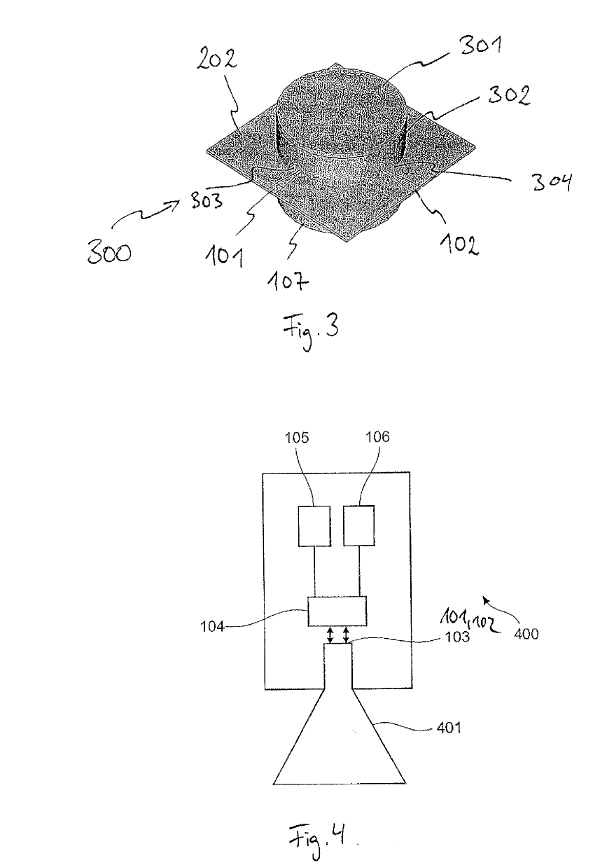

FIG. 3 shows a waveguide transition according to a further exemplary embodiment of the present invention. The waveguide transition 300 has two lines 101, 102, which form an angle of 90° relative to one another and taper at their ends. Both lines 101, 102 are formed as microstrip on a circuit board 202 and extend through both recesses 303, 304 into the waveguide 107, 302.

The circuit board 202 also can be installed different (than in the configuration shown in FIG. 2) with the side that supports the lines or conductors 101, 102 facing the waveguide terminal 107. The backside of the circuit board 202 can be coated with a conductive material, so that the resonator 301, 302 may be eliminated.

FIG. 4 shows a schematic representation of a filling level radar according to a further exemplary embodiment of the present invention.

The filling level radar 400 has a transmitting unit 105 and receiver circuit 106. In addition, an antenna device 401 with a waveguide transition 101, 102, 103 is provided, which is connected to a hybrid coupler 104.

The invention is not limited in its design to the embodiments shown in the figures. In addition, a plurality of variations is contemplated, which make use of the shown solution and the inventive principles also with basically other types of embodiments.

Finally, it is noted that “including” does not exclude other elements or steps and “a” or “one” does not exclude a plurality. In addition, it is noted that the features or steps which are described with reference to the above embodiments also can be sued in combination with other features of steps of other above-described embodiments. Reference numerals in the claims are not to be seen as a limitation.

What is claimed is:

1. A waveguide transition for production of circularly polarized waves for a filling level radar, comprising:
a first line;
a second line; and
a planar emitter element,
wherein the first line, the second line and the planar emitter element interact with each other so that during operation of the filling level radar, a coupling of one of (a) a circularly and (b) an elliptically polarized electromagnetic transmitting signal from the first and second lines into in a waveguide occurs.

2. The waveguide transition of claim 1, further comprising:
a waveguide terminal connecting one of the waveguide, an antenna and a process separator.

3. The waveguide transition of claim 2, wherein the first and second lines extend into the waveguide terminal.

4. The waveguide transition of claim 1, wherein the waveguide transition is embodied for generation of an electromagnetic transmitting signal with two polarization planes; and wherein the first and second lines have an angle of 90° to one another.

5. The waveguide transition of claim 1, wherein a first end of the first line and a second end of the second line each has one of a widening and a narrowing.

6. The waveguide transition of claim 1, wherein the planar emitting element is embodied as a conductive element.

7. The waveguide transition of claim 1, wherein the planar emitting element has a planar structure with two sides lying perpendicular to one another.

8. The waveguide transition of claim 1, wherein the first and second lines are embodied as a microstrip.

9. The waveguide transition of claim 1, further comprising:
a board substrate,
wherein the planar emitting element is manufactured integrally in a board manufacturing process of the board substrate.

10. The waveguide transition of claim 9, wherein the board substrate has an electrically conductive layer on a surface facing away from the emitter element for sealing the waveguide.

11. The waveguide of claim 1, further comprising:
a resonance chamber closing off the waveguide terminal.

12. The waveguide of claim 9, wherein the board substrate has a first dielectricity constant ε₁, wherein the waveguide terminal is filled with a material which has a second dielectricity constant ε₂; and wherein ε₁ is greater or equal to ε₂.

13. The waveguide transition of claim 1, wherein the waveguide transition is embodied for coupling of the electromagnetic transmitting signal with a frequency between 6 Gigahertz and 100 Gigahertz into the waveguide.

14. The waveguide transition of claim 1, wherein the waveguide transition is embodied for coupling of the electromagnetic transmitting signal with a frequency of 6.3 Gigahertz into the waveguide.

15. The waveguide transition of claim 1, wherein the waveguide transition is embodied for coupling of the electromagnetic transmitting signal with a frequency of 26 Gigahertz into the waveguide.

16. The waveguide transition of claim 1, wherein the waveguide transition is embodied for coupling of the electromagnetic transmitting signal with a frequency between 77 Gigahertz and 80 Gigahertz into the waveguide.

17. The waveguide transition of claim 1, further comprising:
a first recess guiding through the first line through the waveguide terminal; and
a second recess guiding through the second line through the waveguide terminal,
wherein the first recess and the second recess are embodied so that they only insignificantly affect an electromagnetic field of a corresponding one of the first and second lines.

18. A microwave module for generating circularly polarized waves for a filling level radar, comprising:
a waveguide transition including a first line, a second line and a planar emitter element,
wherein the first line, the second line and the planar emitter element interact with each other so that during operation of the filling level radar, a coupling of one of (a) a circularly and (b) an elliptically polarized electromagnetic transmitting signal from the first and second lines into in a waveguide occurs.

19. A filling level radar for determining a filling level in a tank, comprising:
an antenna at least one of transmitting and receiving electromagnetic waves; and
a waveguide transition including a first line, a second line and a planar emitter element,
wherein the first line, the second line and the planar emitter element interact with each other so that during operation of the filling level radar, a coupling of one of (a) a circularly and (b) an elliptically polarized electromagnetic transmitting signal from the first and second lines into in a waveguide occurs.

20. Use of a waveguide transition for filling level measurement, the waveguide transition including a first line, a second line and a planar emitter element, wherein the first line, the second line and the planar emitter element interact with each other so that during operation of the filling level radar, a coupling of one of (a) a circularly and (b) an elliptically polarized electromagnetic transmitting signal from the first and second lines into in a waveguide occurs.
